(19) United States
(12) Patent Application Publication
(10) Pub. No.: US 2007/0027815 A1
(43) Pub. Date: Feb. 1, 2007

(54) Systems and methods for centralized subscription and license management in a small networking environment

(75) Inventors: William E. Sobel, Stevenson Ranch, CA (US); Bruce McCorkendale, Manhattan Beach, CA (US); Thomas Powledge, Calabasas, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Symantec Corporation

(21) Appl. No.: 11/192,038

(22) Filed: Jul. 29, 2005

(51) Int. Cl. G06Q 99/00

(52) U.S. Cl. 705/59

(57) ABSTRACT

Methods and Systems are disclosed for a centralized license and subscription management in a small, networked environment may include a licensing/subscription charging service, a licensing/subscription store and a client device licensing/subscription checking component. The licensing/subscription charging service may be located on server, for example, with the software product producer or distributor. The licensing/subscription store may be located on a gateway appliance of the network. The licensing/subscription store may acquire a single licensing/subscription agreement from the licensing/subscription charging service that will cover each of the software products on all of the client devices within the small network.

### DESCRIPTION OF THE INVENTION

1. Field of the Invention

Generally, this invention relates to computer network environments. More specifically, the invention relates to systems and methods for centralized license and subscription management in a small networking environment.

2. Background of the Invention

Software product developers have utilized different methods to protect the intellectual property rights of their software product as well as to acquire additional revenue. Typical examples of these methods are licensing agreements and activation processes, with licensing being the predominant way most consumers acquire software products. For example, when a consumer purchases a software product from a store or pays to download the software product online the consumer does not actually own the software product. Instead, the consumer has only been granted permission to use the software product through acceptance of the licensing agreement. The licensing agreement sets limitations (e.g., software product cannot be copied, the number of devices that the software product may be installed on, etc.) on the use of the software product. The activation process however, generally works through the use of activation keys that identify individual copies of the software product. While the consumer is installing the software product on a computer, the consumer is prompted to enter the activation key before installation can be completed. This requirement helps to prevent an individual copy of the software product from being installed on more devices than allowed by the software product's licensing agreement.

Another method to protect the intellectual property rights of a software product, as well as generate additional revenue, is the subscription method. The subscription method is connected to the licensing agreement in that it allows the user of a licensed software product access to upgrades and updates to the software product. For example, a user of anti-virus software product will often pay a licensing fee to use the software product as well as a subscription fee to be allowed access to updated virus definitions and firewall rules. Further, the licensing and subscription agreements are often only granted for a limited duration of time. Therefore, if a user desires continued use of the software product, or to be able to continue to receive updates after this time period has passed, they are required to consent again to new licensing/subscription agreements.

As a result of the increase in the number of different software products that a particular device may be running and the desire for software product developers to protect their intellectual property rights, there has been a burden placed on consumers to maintain their numerous software product licensing/subscription agreements. This burden is compounded by the fact that many consumers not only have to maintain one computer but several computers. Today, the home and small business computing environment has evolved from a single microcomputer to a small networking environment containing, for example, static desktop computers, mobile laptop or notebook computers, and other static or mobile networked devices (e.g., audio/video equipment, peripheral equipment, personal digital assistants, and the like). Managing licensing/subscription agreements separately for each activated product on each networked device in the small networked environment has become untenable for the typical home and small business network user. Faced with the inconvenience of managing multiple licensing/subscription agreements on each of multiple networked devices, many home and small business network users unfortunately let their licensing/subscription agreements lapse.

Previous solutions to this problem have involved licensing/subscription schemes that use a centralized management service. A centralized management service comprises storing a limited number of licensing/subscription agreements equal to the number of individual software products running on separate client devices onto to one centralized server. For example, a client device may have a particular software product locally stored within its memory nevertheless, for the software product to be fully operational, each time the software product is initialized the software product must connect to the server through a network connection to access the licensing/subscription agreement. This allows the management of the licensing/subscription agreements from one centralized location, the server, instead of at each individual client device. However, because there is still the requirement that the licensing/subscription agreements be continually monitored and updated, as well as the need to provide access to the server for each client device requiring the use of the licensing/subscription agreements, this method still requires a great amount of time to manage. Generally, only the owners of large networks who are able to dedicate considerable resources to the management of the server will find this method beneficial.

Therefore, what is needed are systems and methods that allow the typical home and small business network users to easily maintain all of their software product's licensing/subscription agreements for all of their networked client devices. It is desirable that such systems and methods accomplish this in a manner that is at least as easy and convenient as maintaining a single license/subscription on a single networked client device.

### SUMMARY

In one aspect of the present invention, a system is provided for the management of a software product's licensing/subscription agreements in a computer network. The system comprises a licensing/subscription charging service located on a server; a licensing/subscription store located on a gateway appliance of a computer network and capable of communicating with the licensing/subscription charging service to acquire licensing/subscription agreements for software products running within the network; one or more licensing/subscription checking components located on one or more client devices within the computer network; and wherein a single licensing/subscription agreement for particular software products, stored within the licensing/subscription store, allows all copies of the software products running within the network to be covered by the licensing/subscription agreement.

In another aspect of the invention, a method is provided for the management of a software product's licensing/subscription agreements in a computer network. The method comprises determining whether a licensing/subscription store is preconfigured with a licensing/subscription agreement; initiating communication with a licensing/subscription charging service; providing network identification to the licensing/subscription charging service; determining what licenses/subscriptions are needed for the network; and acquiring the licensing/subscription agreement.

In another aspect of the invention, a computer-readable medium including program instructions for performing, when executed by a processor, a method for the management of a software product's licensing/subscription agreement in a computer network. The method comprises determining whether a licensing/subscription store is preconfigured with a licensing/subscription agreement; initiating communication with a licensing/subscription charging service; providing network identification to the licensing/subscription charging service; determining what licenses/subscriptions are needed for the network; and acquiring the licensing/subscription agreement.

In another aspect of the invention, a method is disclosed for the application of centrally stored licensing/subscription agreement to a computer network. The method comprises initiating within the network a software product subject to a licensing/subscription agreement; sending a request for the license/subscription to the licensing/subscription checking component; checking for a licensing/subscription agreement within a licensing/subscription store; locating and verifying the legitimacy of a licensing/subscription agreement; and applying the licensing/subscription agreement to the software product.

In another aspect of the invention, a computer-readable medium including program instructions for performing, when executed by a processor, a method for applying a centrally stored licensing/subscription agreement to a computer network. The method comprises initiating within the network a software product subject to a licensing/subscription agreement; sending a request for the license/subscription to a licensing/subscription checking component; checking for a licensing/subscription agreement within a licensing/subscription store; locating and verifying the legitimacy of a licensing/subscription agreement; and applying the licensing/subscription agreement to the software product.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate certain aspects of the present invention and together with the description, serve to explain some of the principles associated with the invention.

FIG. 1 illustrates a block diagram of an exemplary system environment, consistent with certain aspects related to the present invention;

FIG. 2 illustrates a block diagram of an exemplary gateway appliance, consistent with certain aspects related to the present invention;

FIG. 3 illustrates a block diagram of an exemplary server, consistent with certain aspects related to the present invention;

FIG. 4 illustrates a block diagram of an exemplary client device, consistent with certain aspects related to the present invention;

FIG. 5 illustrates a flowchart of an exemplary licensing/subscription management process, consistent with certain aspects related to the present invention; and

FIG. 6 illustrates a flowchart of an exemplary licensing/subscription application process consistent with certain aspects related to the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with certain aspects related to the invention.

Overview

Methods and systems consistent with certain aspects of the present invention provide for the management of licensing/subscription agreements for software product within a small computer network environment through the use of a gateway appliance. In one aspect, the gateway appliance provides a centralized single licensing/subscription agreement within a network and allows for that single licensing/subscription agreement to cover multiple software products located on the multiple devices that comprise the network. The gateway appliance may receive the licensing/subscription agreements through a network connection with a server maintained by the software product producer or distributor. The licensing/subscription agreements may be delivered to the gateway appliance as a digitally signed data file. In another aspect, the gateway appliance may be preconfigured to include licensing/subscription agreements. For example, the gateway appliance may be purchased with the licensing subscription agreements already preloaded by the producer or creator of the software product. Moreover, all devices connected to the gateway appliance may utilize the licensing/subscription agreements. The terms of the licensing/subscription agreement may, however, limit the utilization of the licensing/subscription agreement to a finite number of client devices connected to the gateway appliance.

Therefore, the license/subscription is granted to the network and not to individual devices. Particularly, the license/subscription is stored within the gateway appliance for the network. For instance, if a client device is running a software product subject to a licensing/subscription agreement, then once that client device is connected to the network, the software product will be covered by that licensing/subscription agreement (i.e., the software product will be able to function under the terms of the licensing/subscription agreement stored within the gateway appliance). Additionally, the terms of the licensing/subscription agreement may be configured to allow the software product located on mobile client devices to still be covered by the licensing/subscription agreement even while the mobile client device is not connected to the gateway appliance. Further, the gateway appliance will periodically manage the updating of the licensing/subscription agreement by communicating with an external server maintained by the producer or distributor of the software product.

The foregoing discussion is intended to introduce and provide initial clarity for some of the aspects associated with the present invention. Further details of the above-mentioned functionality and additional aspects, features, and embodiments of the present invention are described below.

Exemplary System Environment

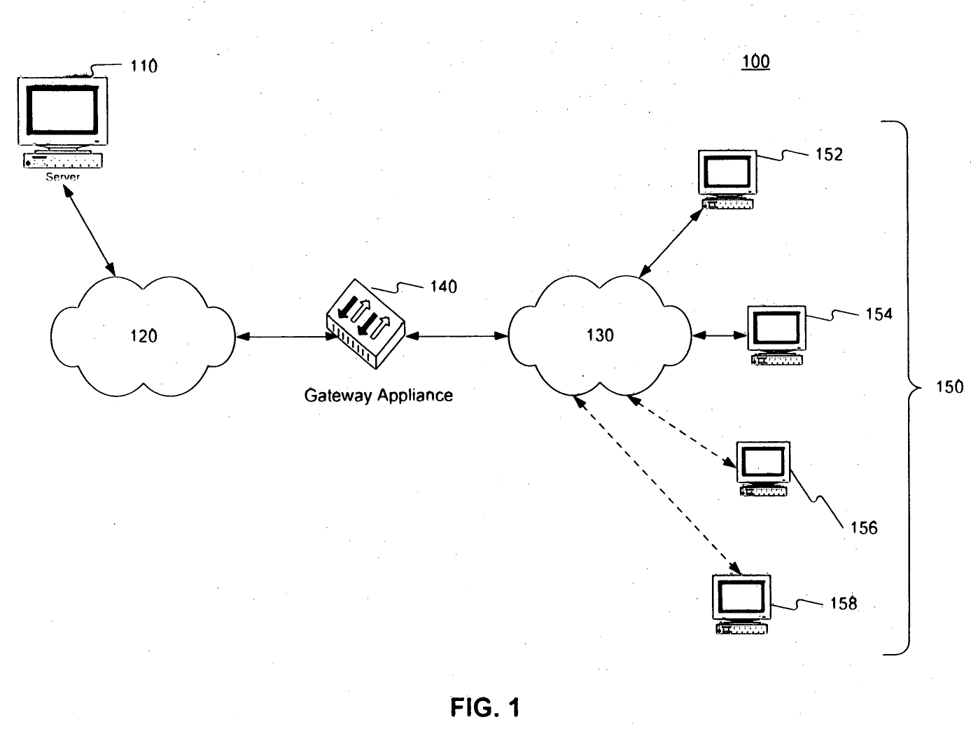

FIG. 1 illustrates a block diagram of an exemplary system environment 100 consistent with certain aspects related to the present invention. As shown, system environment 100 may include a network 120, server 110 connected to network 120, network 130, client devices 150, connected to network 130, and a gateway appliance 140 interfacing both network 120 and network 130. Client devices 150 may all contain software products 407 subject to licensing/subscription agreements and a licensing/subscription checking component 414.

Network 120 may be any wired, wireless, or combination network that is capable of interconnecting server 110 with network 130. For example, network 120 may be the Internet or may be any proscribed network within another organizational entity. Server 110 may be operated, for example, by the producer or distributor of computer software product 407. Server 110 may be one or more computer servers that are collocated with each other or distributed across multiple locations. Network 130 may be a private network consisting one or more network segments with restricted network access, such as a computer network that belongs to a business organization or a home office and designed to be accessible only to designated users. Network 130 may be, for example, a wired network, a wireless network, or a combination wired/wireless network.

Gateway appliance 140 may be any device capable of interconnecting network 130 to network 120. For example, gateway appliance 140 maybe be a modem, a router, a switch, a firewall, or a combination of these or similar equipment, as well as one or more computing devices that may include one or more of these functions either in hardware, software, or a combination of hardware and software. Each client device 150 may be any type of home or office network-capable device that may include software product 407 subject to a licensing/subscription agreement, for example: a personal computer, a laptop or notebook computer, a personal digital assistant (PDA), a cellular telephone, a home appliance (e.g., refrigerator, alarm system, air conditioner, etc.), audio/video equipment (e.g., television, cable box, receiver, etc.), office equipment (e.g., fax device, copier, etc.) and the like. In certain aspects of the invention, client devices 150 may include, for example, one or more static client devices 152, 154 and one or more mobile client devices 156, 158.

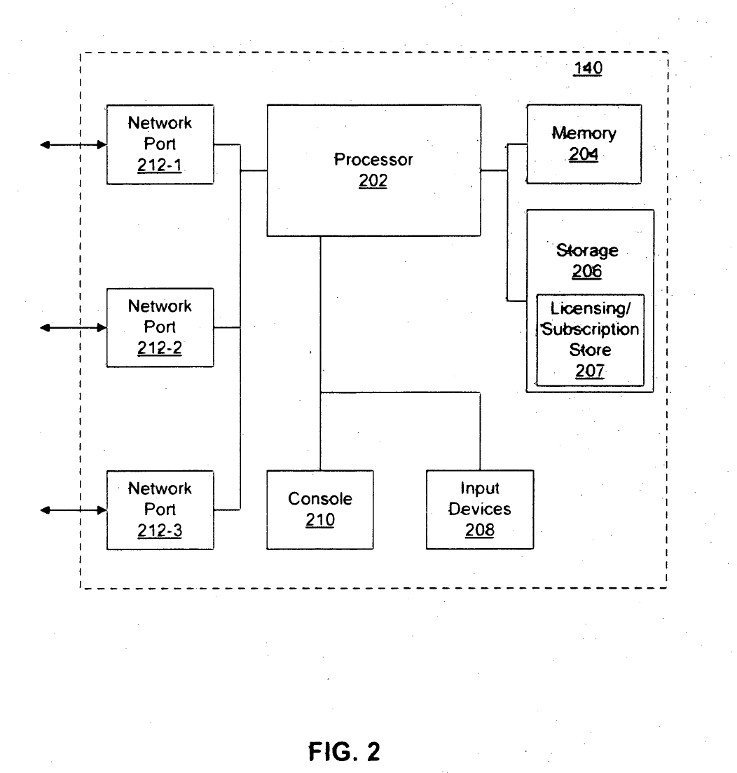

FIG. 2 is an exemplary embodiment of a gateway appliance 140. As shown, gateway appliance 140 comprises a processor 202, a memory 204, a storage 206, an I/O interface 208, input devices 210, an optional console 214, and multiple network interfaces 212-1 to 212-3. It is understood that the types and number of the listed devices are exemplary only and not limiting. The number of any or all of the listed devices may be changed, some devices may be removed, and other devices may be added without departing the principle and scope of the present invention.

Processor 202 may be one or more general purpose microprocessors or special processors such as network processors or digital signal processors (DSPs). Alternatively, processor 202 may be one or more application-specific integrated circuits (ASICs). Processor 202 may be configured as a central processing unit for gateway appliance 140, or, alternatively, as a combination of a central processing unit for gateway appliance 140 and distributed processing units from network interfaces 212-1 to 212-3. Processor 202 may be any combination of general purpose processors and specialized hardware or one or the other. Memory 204 may be one or more memory devices including, but not limited to, a ROM, a flash memory, a dynamic RAM, and a static RAM. Memory 204 may be configured to store information used by processor 202 and other devices inside gateway appliance 140. Storage 206 may be one or more hard disk devices, optical disk devices, or other storage devices to provide storage space for gateway appliance 140. Storage 206 may be used to store security technologies, record user information, system information, log messages, databases or other run-time information.

I/O interface 208 may be one or more input/output devices receiving data from processor 202 and sending data to processor 202. Input devices 210 may include a keyboard, a mouse, or other optical or wireless computer input devices. Console 214 may be one or more computer screens configured to display information to administrators or users.

Network interfaces 212-1 to 212-3 may be separate communication modules (i.e., network adaptors) capable of plugging into gateway appliance 140. Each of network interfaces 212-1 to 212-3 may have one or more network ports. Each of network interfaces 212-1 to 212-3 may also have dedicated processor units and software programs to process network traffic. Network interfaces 212-1 to 212-3 may be connected to different network segments. For example, one of network interfaces 212-1 to 212-3 may be connected to network 130; one of network interfaces 212-1 to 212-3 may be connected to Internet 120. The number of the network interfaces is exemplary only and not intended to be limiting, any number of network interfaces may be used.

Within the storage device 206 is the licensing/subscription store 207. The licensing/subscription store 207 may contain a licensing/subscription agreement for multiple software products 407 located on client devices 150. In one aspect, the management of the licensing/subscription store 207 may be accomplished through console 214 and input devices 210. In another aspect, the management of the licensing/subscription store 207 may be accomplished through client devices 150 connected to the gateway appliance 140. The administrator of network 130 will therefore not have to manage the licensing/subscription agreements of individual client devices 150, but instead only manage the updating of the licensing/subscription agreements of the licensing/subscription store 207. Further, the administrator need not acquire licensing/subscription agreements for each individual client devices 150, since a single licensing/subscription agreement, stored within the licensing/subscription store 207, will cover multiple software products 407 (or all software products 407) running on all client devices 150 that comprise network 130.

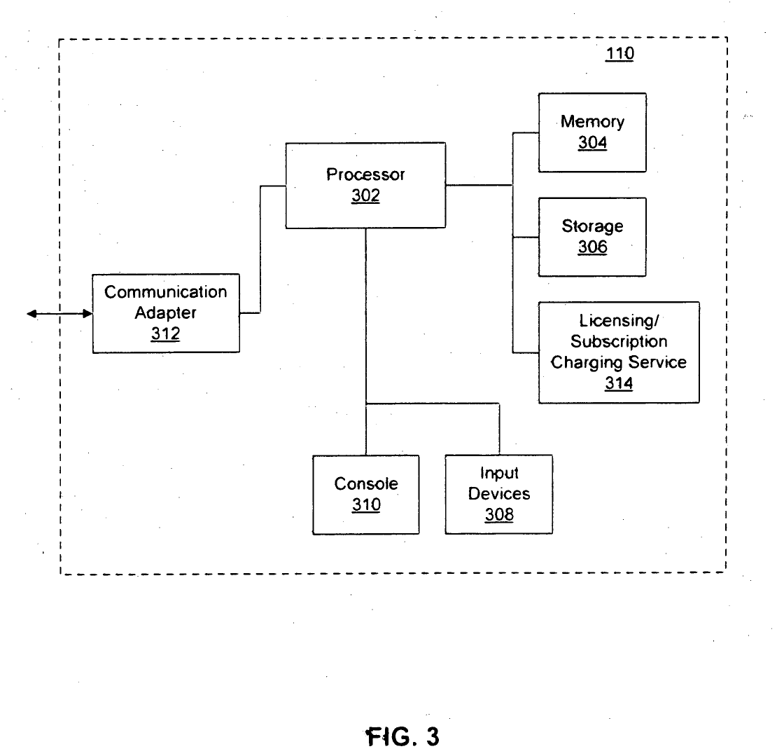

FIG. 3 is an exemplary embodiment of server 110. Server 110 includes the typical components of a computer system. For example, as shown, server 110 may include a processor 302, memory 304, and storage 306. Also, server 110 may include input devices 308 which may include a keyboard, a mouse, or other optical or wireless computer input devices and a console 310 which may be one or more computer screens configured to display information to administrators or users. Server 110 may further include a communication adaptor 312 that allows the server 110 to be interconnected to additional computing resources via a local area network (LAN) or a wide area network (WAN), such as network 120. Server 110 may also contain a licensing/subscription charging service 314.

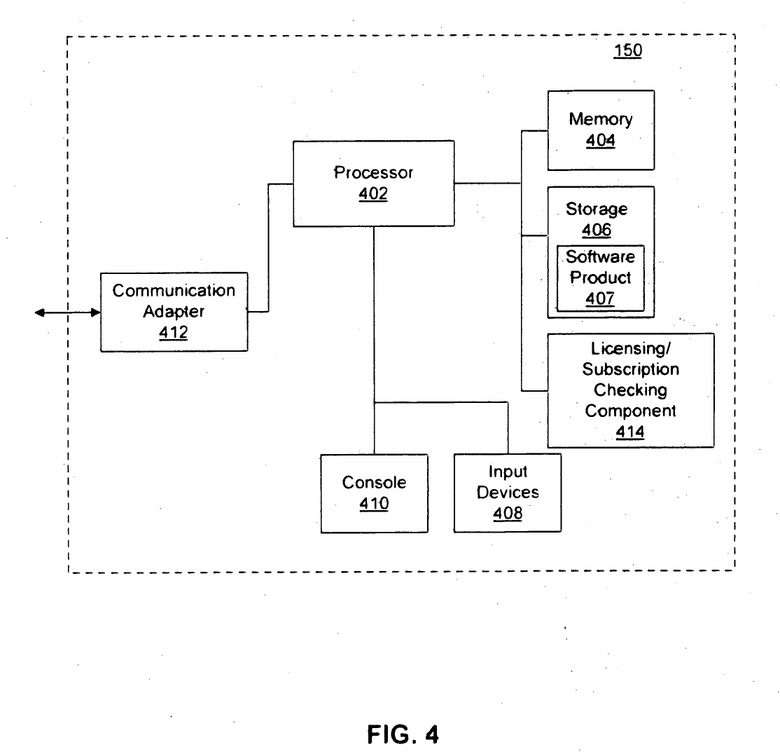

FIG. 4 is an exemplary embodiment of client devices 150. Similar to server 110, client devices 150 include the typical components of a computer system. For example, as shown, client devices 150 may include a processor 402, memory 404, and storage 406. Software product 407, subject to a licensing/subscription agreement, may be stored within storage 406. In addition, client devices 150 may include input devices 408, which may include a keyboard, a mouse, or other optical or wireless computer input devices and a console 410 which may be one or more computer screens configured to display information to administrators or users. Client devices 150 may further include, a communication adaptor 412 that allows client devices 150 to be interconnected to additional computing resources via a local area network (LAN) or a wide area network (WAN), such as network 130 and 120 via gateway appliance 140. Client devices 150 also contain a licensing/subscription checking component 414. The licensing/subscription checking component 414 is a shared component used by the software products 407 running on each client device 150 that require a licensing/subscription agreement to be fully operational (e.g., ability to use the software product or get updates to the software product).

Acquiring a Single Licensing/Subscription Agreement for the Entire Network

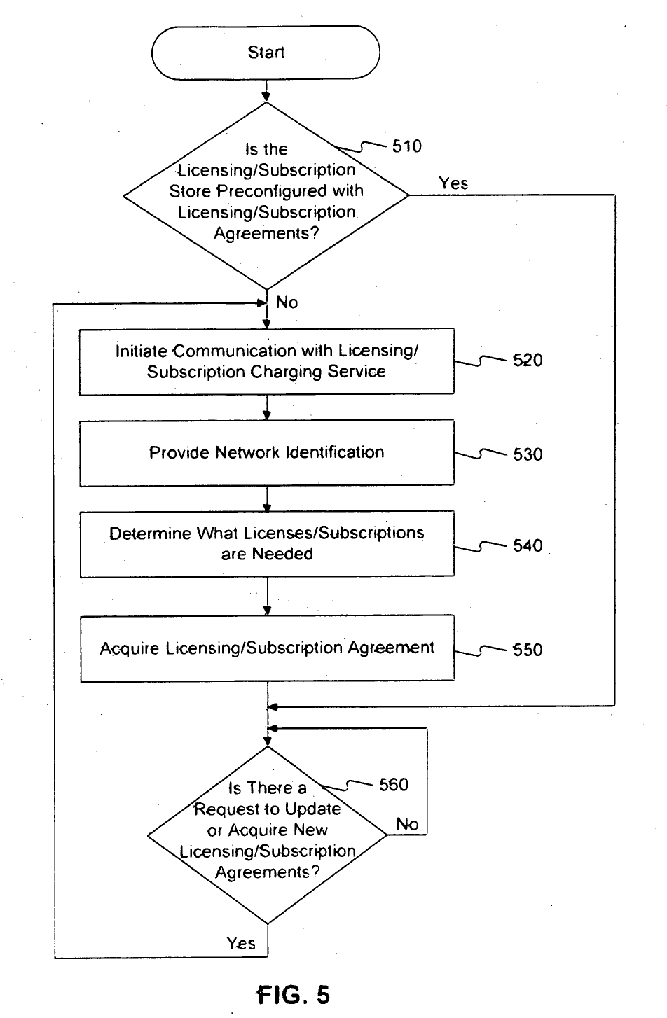

As explained, aspects of the present invention enable a single licensing/subscription agreement for software products 407 to cover an entire network 130 of client devices 150. In accordance with the aspects of the present invention, the licensing/subscription charging service 314 stores the required licensing/subscription agreements for the software products 407, located on client devices 150. FIG. 5 illustrates a flowchart of an exemplary licensing/subscription agreement management process. Initially, the necessary licensing/subscription agreement required for the software products 407, that are running on client device 150, are acquired by the licensing/subscription store 207. In one aspect of the invention, the licensing/subscription store may be preconfigured by the producer or distributor of the software product 407 to already include the required licensing/subscription agreement. In this instance, software product 407 will be covered by the terms of the licensing/subscription agreement once the client device 150 is connected to the gateway appliance 140, without the need for the gateway appliance 140 to first connect to server 110 (Step 510; YES). However, if the licensing/subscription store is not preconfigured with licensing/subscription agreements, then the licensing/subscription agreements may be acquired from the licensing/subscription charging service 314 (Step 510; NO). Subsequently, gateway appliance 140 establishes a communication connection with server 110 (Step 520). The communication between the gateway appliance 140 and the server 110 is governed by defined protocols. For example, the Transmission Control Protocol/Internet Protocol (TCP/IP) is a combined set of protocols that performs the transfer of data between two computers and is used to connect hosts on the Internet.

Once communication between the gateway appliance 140 and the server 110 has been established, network 130 is identified to the server 110 (Step 530). Network 130 may be identified through any number of fingerprinting techniques. Identification of network 130 allows the licensing/subscription charging service 314 to selectively distribute licensing/subscription agreements to the appropriate networks (e.g., networks that have paid for the licensing/subscription agreement). For example, the acquisition of the Internet Protocol (IP) address, Media Access Control (MAC) address, serial number, or any other unique characteristics of gateway appliance 140 may be considered to provide a fingerprint of network 130. A fingerprint of network 130 may also be obtained by using the MAC addresses of devices connected both downstream (e.g., client devices 150) and upstream (e.g. DSL cable modem, ISP router, etc.) of gateway appliance 140. This information may further be combined with other information, such as the Internet Service Provider (ISP) Domain Name System (DNS) server addresses in order to get a more detailed fingerprint of the network 130. Subsequently, a determination is made as to what type of licenses/subscriptions are needed based upon what type of software products 407 are being run on the client devices 150 and preferences set forth by the administrator (Step 540). For example, the administrator of network 130 may designate how large a license/subscription is needed based upon how many client devices 150 that currently comprise or that are expected to comprise network 130. Thus, if network 130 will only ever be comprised of five client devices 150 running the particular software product 407 requiring a license/subscription, the administrator may request a license/subscription that will cover a network 130 consisting of up to five client devices 150.

In one aspect of the invention, a small network environment administrator may purchase a single licensing/subscription for the licensing/subscription store 207 to allow unfettered access to all of the license/subscription based content for one or more software products 407 for up to a maximum allowed number of networked client devices 150 for some time period. As an example, for $100.00 per year, the administrator may purchase a single license/subscription that covers an entire software suite, along with all updates for each, for up to five client devices located within network 130. A software suite is a collection of software products, which usually share related functionality and some ability to smoothly exchange information with each other. For example, a software suite may include an antivirus, a firewall, and a content filter software product. In another example, the single license/subscription may only cover all versions of the antivirus software product running with the network 130 and thereby require another single license/subscription for the firewall software product and the content filter software product. It is also possible that the single license/subscription may cover all software products of a particular software producer that are running within the network 130. Of course, many other variations of the conditions, terms, and prices are possible and such variations are meant to be within the scope of the invention.

In a further aspect of the invention, one or more of the client devices 150 may be designated as mobile, and thus allowed to roam in and out of network 130, yet software products 407 remain covered by the licensing/subscription agreement as if within network 130. This may be accomplished, for example, by issuing to the administrator of network 130 a certain number of roaming licenses/subscriptions to cover mobile clients 156, 158 in excess of the single licensing/subscription agreement that covers network 130. This may be permitted to allow the administrator to designate some number of the total client devices 150 from network 130 as being mobile (i.e. client devices that enter and leave the environment while maintaining the same security and protection provided to the environment). In operation, upon initial configuration of the licenses/subscriptions of the licensing/subscription store 207, the administrator may be presented with a list of client devices 150 currently detected within the environment and then be asked to designate those that are allowed to be mobile client devices 156, 158. The administrator may be allowed to designate some number of the client devices 150, but may later change or transfer the mobile license/subscriptions from one client device 150 to another as needed (i.e., using license check-in and check-out actions). The licensing/subscription agreements of all client devices 150 in the network 130 not designated as mobile (e.g., static client devices 152, 154), are managed through the use of licensing/subscription store 207. The mobile licenses/subscriptions may, for example, require an additional purchase above that for the single licensing/subscription agreement maintained within the licensing/subscription store 207.

In another aspect of the invention, the software product 407 on the mobile client device may be covered by the single licensing/subscription agreement and therefore not require additional licenses/subscriptions. This may be accomplished, for example, by allowing the mobile client device 156, 158 to be covered by the single licensing/subscription agreement while connected to the network 130. However, if the mobile client device 156, 158 is disconnected from the network 130, the software product 407 may remain covered by the licensing/subscription agreement for a limited period of time. For example, the software product 407 of a mobile client device 156, 158 may remain covered by the single licensing/subscription agreement for a period of seven days while it is disconnected from the network 130. If the mobile client device 156, 158 does not reconnect to the network 130 within the seven-day period, the software product may no longer be covered by the single licensing/subscription agreement and thus may revert back to its default licensing/subscription behavior (e.g., licensing/subscription management on a per-installation, per-product, per-client, etc., basis).

After it has been determined what licensing/subscription agreements are needed the licensing/subscription agreements are stored within gateway device 140 (Step 550). In particular, the licensing/subscription agreements are stored within the licensing/subscription store 207. The licensing/subscription agreements may be delivered to the licensing/subscription store 207 as a digitally signed data file. A digital signature is an encrypted electronic signature that may be used to authenticate a file and the identity of the file creator. Therefore, a digital signature may be used to ensure that the file originated with the entity signing it and that it was not tampered with after the signature was applied. As is usual for licensing/subscription schemes, the signed data file representing the purchased license/subscription may contain, for example, information about the terms and period of the license/subscription. The terms and period may represent any value that the rights holder desires. To limit transferability of the data file, the signed file representing the license/subscription may include a fingerprint or identifier unique to the network to which it belongs. This fingerprint may include a combination selected from an Internet Protocol (IP) address, a Media Access Control (MAC) address, a serial number, or any other unique characteristics of the gateway appliance.

Further, the gateway appliance 140 will periodically manage the licensing/subscription agreements stored within the licensing/subscription store 207 (Step 560). The management process may be initiated, for example, through a request from the administrator or in response to specified time or event (e.g., when a licensing/subscription agreement is about to expire). In certain aspects of the invention, the administrator of network 130 may manage the licensing/subscription store 207 only once per licensing period on the gateway device 140 regardless of the number of client devices 150 or software products 407 that end up on the network (i.e., as long as the licensing/subscription store 207 at least covers each of the software products 407 and the maximum number of client devices 150 within network 130).

Applying the Licensing/Subscription Agreement to a Software Product

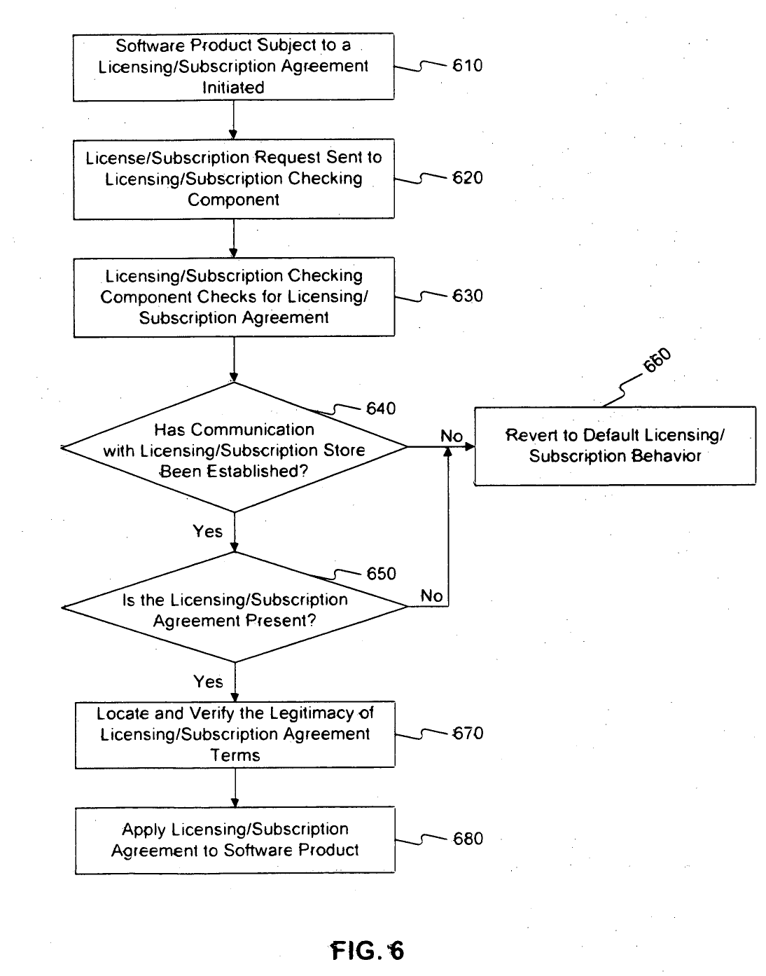

As explained, the licensing/subscription agreements stored on gateway appliance 140 are not designated for one particular client device 150, but instead cover the entire network 130. Therefore, the software product 407 of any client device 150 connected to network 130 may be covered by the licensing/subscription agreements stored within the licensing/subscription store 207. FIG. 6 illustrates a flowchart of an exemplary licensing/subscription agreement application process wherein the particular software products 407 acquire coverage from the licensing/subscription store 207. The process begins by initiation of a particular software product 407 on one of the client devices 150 (Step 610). During the initiation of the software product 407, a request is sent to the licensing/subscription checking component 414 seeking the required license/subscription needed for the software product 407 (Step 620). In response, the licensing/subscription checking component 414 checks for the required license/subscription on the licensing/subscription store 207 (Step 630). The licensing/subscription checking component 414 may discover and use the licensing/subscription store 207 of gateway appliance 140 through, for example, a discovery and usage protocol. Any of a number of protocols may work for example, local broadcast, challenge-response on a given port of the gateway appliance 140, and the like.

In one aspect of the invention, a determination is made as to whether a communication with the licensing/subscription store has been established (Step 640). If the licensing/subscription store 207 cannot be found or the license/subscription for that particular software product 407 is not present (Step 650), then that client device may revert to its default licensing behavior (e.g., licensing/subscription management on a per-installation, per-product, per-client, etc., basis) (Step 660). However, if the licensing/subscription store is found, then the license/subscription for that particular software product 407 is located and verified (Step 670). The license/subscription may be verified by noting that its terms are applicable to the software product 407 being executed. Once the verification is complete, the license/subscription is applied to the software product 407 thus enabling the software product 407 to be fully operational under the terms of the licensing/subscription agreement (Step 680).

### CONCLUSION

Although the present invention has been particularly described with reference to certain aspects thereof, it should be readily apparent to those of ordinary skill in the art that various changes, modifications, deletions and substitutes are intended within the form and details thereof, without departing from the spirit and scope of the invention. For example, implementation details that mention software, hardware and firmware are interchangeable and combinatory. Wireless and wired networks are also interchangeable and combinatory. Mention of a server or device may be a combination of devices or servers, without limitation. It is intended that the scope of the appended claims include such variations, substitutions, changes and modifications.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for providing for the management of a software product's licensing/subscription agreements in a computer network, comprising:
a licensing/subscription charging service located on a server;
a licensing/subscription store located on a gateway appliance of a computer network and capable of communicating with the licensing/subscription charging service to acquire licensing/subscription agreements for software products running within the network;
one or more licensing/subscription checking components located on one or more client devices within the computer network; and
wherein a single licensing/subscription agreement for particular software products, stored within the licensing/subscription store, allows all copies of the software products running within the network to be covered by the licensing/subscription agreement.

2. The system of claim 1, wherein the particular software product includes all software products of a particular software producer.

3. The system of claim 1, wherein the particular software product includes a particular software suite.

4. The system of claim 1, wherein the particular software product includes an individual software product.

5. The system of claim 1, wherein the licensing/subscription store includes more than one single licensing/subscription agreement.

6. The system of claim 1, wherein the gateway appliance is preconfigured with a licensing/subscription agreement.

7. The system of claim 1, wherein the client devices include static and mobile client devices.

8. The system of claim 7, wherein the software products running within the mobile client devices are still covered by the single licensing/subscription agreement when the mobile client devices are disconnected from the network.

9. The system of claim 8, wherein the mobile client devices while disconnected from the network are covered by the single licensing/subscription agreement for a limited period of time.

10. The system of claim 9, wherein if the mobile client devices do not reconnect to the network within the limited period of time, the software products revert back to their default licensing/subscription behavior.

11. The system of claim 7, wherein the licensing/subscription store includes roaming licenses/subscriptions for the mobile client devices.

12. The system of claim 11, wherein the mobile client device checks out roaming licenses/subscriptions when it disconnects from the network and checks in the roaming licenses/subscriptions when it reconnects to the network.

13. The system of claim 11, wherein the roaming licenses/subscriptions are delivered to the licensing/subscription store as a digitally signed data file.

14. The system of claim 1, wherein the single licensing/subscription agreement is delivered to the licensing/subscription store as a digitally signed data file.

15. A method for providing for the management of a software product's licensing/subscription agreement in a computer network, comprising:
determining whether a licensing/subscription store is preconfigured with a licensing/subscription agreement;
initiating communication with a licensing/subscription charging service;
providing network identification to the licensing/subscription charging service;
determining what licenses/subscriptions are needed for the network; and
acquiring the licensing/subscription agreement.

16. The method of claim 15, wherein the licensing/subscription store is located on a gateway appliance connected to the network.

17. The method of claim 15, wherein the licensing/subscription agreement allows all copies of the software products running within the network to be covered by the licensing/subscription agreement.

18. The method of claim 17, wherein the software products include all software products of a particular software producer.

19. The method of claim 17; wherein the particular software product includes a particular software suite.

20. The method of claim 17, wherein the particular software product includes an individual software product.

21. The method of claim 15, wherein initiating communication with a licensing/subscription charging service is governed by defined communication protocols.

22. The method of claim 21, wherein the defined communication protocol is the Transmission Control Protocol/Internet Protocol (TCP/IP).

23. The method of claim 15, wherein providing network identification comprises:
implementing a fingerprinting technique.

24. The method of claim 23, wherein the fingerprinting technique uses an Internet Protocol (IP) address, a Media Access Control (MAC) address, a serial number, or any other unique characteristic of the gateway appliance.

25. The method of claim 23, wherein the fingerprinting technique comprises:
the use of the MAC addresses of devices connected both downstream and upstream of the gateway appliance.

26. The method of claim 25, wherein the fingerprinting technique further comprises:
the use of the Internet Service Provider (ISP) Domain Name System (DNS) server addresses.

27. The method of claim 15, wherein determining what licenses/subscriptions are needed for the network comprises:
considering what type of software products are being run within the network and preferences set by an administrator.

28. The method of claim 15, wherein acquiring the licensing/subscription agreement comprises:
acquiring the licensing/subscription agreement as a digitally signed data file.

29. A computer-readable medium including program instructions for performing, when executed by a processor, a method for the management of a software product's licensing/subscription agreement in a computer network, comprising:
determining whether a licensing/subscription store is preconfigured with a licensing/subscription agreement;
initiating communication with a licensing/subscription charging service;
providing network identification to the licensing/subscription charging service;
determining what licenses/subscriptions are needed for the network; and
acquiring the licensing/subscription agreement.

30. The method of claim 29, wherein the licensing/subscription store is located on a gateway appliance connected to the network.

31. The method of claim 29, wherein the licensing/subscription agreement allows all copies of the software products running within the network to be covered by the licensing/subscription agreement.

32. The method of claim 31, wherein the software products include all software products of a particular software producer.

33. The method of claim 31, wherein the particular software product includes a particular software suite.

34. The method of claim 31, wherein the particular software product includes an individual software product.

35. The method of claim 29, wherein initiating communication with a licensing/subscription charging service is governed by defined communication protocols.

36. The method of claim 35, wherein the defined communication protocol is the Transmission Control Protocol/Internet Protocol (TCP/IP).

37. The method of claim 29, wherein providing network identification comprises:
implementing a fingerprinting technique.

38. The method of claim 37, wherein the fingerprinting technique uses
an Internet Protocol (IP) address, a Media Access Control (MAC) address, a serial number, or any other unique characteristic of the gateway appliance.

39. The method of claim 37, wherein the fingerprinting technique comprises:
the use of the MAC addresses of devices connected both downstream and upstream of the gateway appliance.

40. The method of claim 39, wherein the fingerprinting technique further comprises:
the use of the Internet Service Provider (ISP) Domain Name System (DNS) server addresses.

41. The method of claim 29, wherein determining what licenses/subscriptions are needed for the network comprises:
considering what type of software products are being run within the network and preferences set by an administrator.

42. The method of claim 29, wherein acquiring the licensing/subscription agreement comprises:
acquiring the licensing/subscription agreement as a digitally signed data file.

43. A method for the application of centrally stored licensing/subscription agreement to a computer network, comprising:
initiating within the network a software product subject to a licensing/subscription agreement;
sending a request for the license/subscription to a licensing/subscription checking component;
checking for a licensing/subscription agreement within a licensing/subscription store;
locating and verifying the legitimacy of a licensing/subscription agreement; and
applying the licensing/subscription agreement to the software product.

44. The method of claim 43, wherein the licensing/subscription store is located on a gateway appliance connected to the network.

45. The method of claim 43, wherein checking for a licensing/subscription agreement within a licensing/subscription store further comprises:
discovering the licensing/subscription store through a discovery and usage protocol.

46. The method of claim 45, wherein the discovery and usage protocol comprises:
either a local broadcast or a challenge-response on a given port of the gateway appliance.

47. The method of claim 43, wherein verifying the legitimacy of the licensing/subscription agreement comprises:
determining whether the terms of licensing/subscription agreement are applicable to the software product.

48. A computer-readable medium including program instructions for performing, when executed by a processor, a method for applying a centrally stored licensing/subscription agreement to a computer network, the method comprising:
initiating within the network a software product subject to a licensing/subscription agreement;
sending a request for the license/subscription to a licensing/subscription checking component;
checking for a licensing/subscription agreement within a licensing/subscription store;
locating and verifying the legitimacy of a licensing/subscription agreement; and applying the licensing/subscription agreement to the software product.

49. The method of claim 48, wherein the licensing/subscription store is located on a gateway appliance connected to the network.

50. The method of claim 48, wherein checking for a licensing/subscription agreement within a licensing/subscription store further comprises:
discovering the licensing/subscription store through a discovery and usage protocol.

51. The method of claim 50, wherein the discovery and usage protocol comprises:
either a local broadcast or a challenge-response on a given port of the gateway appliance.

52. The method of claim 48, wherein verifying the legitimacy of the licensing/subscription agreement comprises:
determining whether the terms of licensing/subscription agreement are applicable to the software product.
